(19) United States
(12) Patent Application Publication
(10) Pub. No.: US 2024/0223844 A1
(43) Pub. Date: Jul. 4, 2024

(54) CONTENT SHARING METHOD USING DUMMY MEDIA, ELECTRONIC DEVICE AND COMPUTER PROGRAM

(71) Applicant: KINEMASTER CORPORATION, Seoul (KR)

(72) Inventor: Jong Deuk KIM, Seongnam-si (KR)

(73) Assignee: KINEMASTER CORPORATION, Seoul (KR)

(21) Appl. No.: 18/557,862

(22) PCT Filed: Apr. 29, 2022
(86) PCT No.: PCT/KR2022/006185

§ 371 Date: Oct. 27, 2023

(30) Foreign Application Priority Data
Apr. 29, 2021 (KR) 10-2021-0055938
Apr. 29, 2022 (KR) 10-2022-0053446

(51) Int. Cl. H04N 21/431; G06F 3/0482; H04N 21/234

(52) U.S. Cl. CPC H04N 21/4318; G06F 3/0482; H04N 21/23424

(57) ABSTRACT

Disclosed herein a content sharing method using dummy media, electronic device and computer program. The electronic device includes: an editing UI display unit configured to provide an editing UI including a dummy media creation UI to a display device; a user input checking unit configured to check user input information received through the dummy media creation UI; and an editing UI processing unit configured to create at least one dummy media according to input of the dummy media creation UI based on the user input information checked by the user input checking unit and to perform processing to share a video project including the dummy media according to a request.

### TECHNICAL FIELD

The present disclosure relates to a content sharing method, device and computer program using dummy media, and more particularly, to a content sharing method, device and computer program using dummy media, which are capable of reducing the sharing capacity of content and protecting privacy of a user included in the content.

### BACKGROUND ART

Recently, as portable terminals such as smartphones and tablets have been widely spread, performance of these portable terminals has been improved and wireless communication technology has been developed, users can shoot, edit, and share videos using their portable terminals.

However, in portable terminals, due to limitations in the size of a display and performance of hardware, users cannot smoothly edit videos as in a general PC environment. In order to improve this inconvenience, user demand for a video editing method that can be used in a portable terminal is increasing.

Furthermore, as the needs of users of portable terminals increase, the performances of camera devices, display devices, and hardware of portable terminals are being upgraded, and many functions or services used in PC environments are being performed by portable terminals. In particular, since portable terminals are basically provided with a camera device, user needs for editing images or videos captured through the camera device are increasing.

Meanwhile, video editing may be performed using original media such as photos and videos stored in a portable terminal. When a user configures a video project using the edited original media and shares it with other users, if the original media has a large capacity, a lot of burden may be induced in sharing transmission and related networks. Moreover, when personalized information is included in the edited media, the personalized information is exposed to other users through sharing, and there is a problem in that privacy is not protected.

### DISCLOSURE

### Technical Problem

An object of the present disclosure is to provide a content sharing method, device and computer program using dummy media, which are capable of reducing the sharing capacity of content and protecting privacy of a user included in the content.

The technical problems solved by the present disclosure are not limited to the above technical problems and other technical problems which are not described herein will be clearly understood by a person having ordinary skill in the technical field, to which the present disclosure belongs, from the following description.

### Technical Solution

According to the present disclosure, there is provided an electronic device for sharing content using dummy media, the electronic device comprising: an editing UI display unit configured to provide an editing UI including a dummy media creation UI to a display device; a user input checking unit configured to check user input information received through the dummy media creation UI; and an editing UI processing unit configured to create at least one dummy media according to input of the dummy media creation UI based on the user input information checked by the user input checking unit and to perform processing to share a video project including the dummy media according to a request.

According to the embodiment of the present disclosure in the electronic device, the editing UI processing unit may be configured to: detect individual media information as information on at least one media included in a video project and create dummy media information based on the individual media information, and perform processing to share the video project by including the dummy media information in the video project.

According to the embodiment of the present disclosure in the electronic device, the individual media information may comprise at least one of a type of media, resolution of media or time information of media.

According to the embodiment of the present disclosure in the electronic device, the editing UI processing unit may generate respectively dummy media information for all media included in the video project or generate dummy media information for selected media among at least one media included in the video project.

According to the embodiment of the present disclosure in the electronic device, the editing UI may comprise a dummy media replacement UI configured to check whether at least one dummy media exists in the video project and to determine alternative media corresponding to the dummy media.

According to the embodiment of the present disclosure in the electronic device, the editing UI processing unit may comprise a dummy media processing unit configured to check whether at least one dummy media exists in the video project based on the dummy media information in response to input of a shared video project, to determine alternative media corresponding to the dummy media according to a request in response to existence of the dummy media, and to replace the dummy media with the alternative media in the video project.

According to the embodiment of the present disclosure in the electronic device, the dummy media processing unit may be configured to compare a type of the dummy media, resolution of the dummy media and time information of the dummy media with a type of the alternative media, resolution of the alternative media and time information of the alternative media.

According to the embodiment of the present disclosure in the electronic device, the dummy media processing unit may be configured to select the alternative media in consideration of whether the type of the dummy media, the resolution of the dummy media and the time information of the dummy media match the type of the alternative media, the resolution of the alternative media and the time information of the alternative media.

According to the embodiment of the present disclosure in the electronic device, the dummy media processing unit may be configured to control the alternative media in consideration of whether the type of the dummy media, the resolution of the dummy media and the time information of the dummy media match the type of the alternative media, the resolution of the alternative media and the time information of the alternative media.

According to the embodiment of the present disclosure in the electronic device, the dummy media processing unit may be configured to: extract media capable of replacing the dummy media in consideration of the type of the dummy media, the resolution of the dummy media, the time information of the dummy media, the type of the alternative media, the resolution of the alternative media and the time information of the alternative media, providing a list of the extracted media, and determining at least one alternative media from the extracted media.

According to another present disclosure, there is provided a content sharing method using dummy media, the method comprising: providing an editing UI including a dummy media creation UI; checking user input information received through the dummy media generation UI; creating at least one dummy media according to input of the dummy media creation UI based on the user input information checked by the user input checking unit; and performing processing to share a video project including the dummy media according to a request.

According to another present disclosure, there is provided A computer a program stored in a recording medium readable by a computing electronic device in order to perform a content sharing method using dummy media in a computing electronic device, the method comprising: providing an editing UI including a dummy media creation UI; checking user input information received through the dummy media generation UI; creating at least one dummy media according to input of the dummy media creation UI based on the user input information checked by the user input checking unit; and performing processing to share a video project including the dummy media according to a request.

### Effects of Invention

According to the present disclosure, it is possible to provide a content sharing method, device and computer program using dummy media, which are capable of reducing the sharing capacity of content and protecting privacy of a user included in the content.

Specifically, by replacing or inserting a dummy image with or into a video project and sharing the video project, the storage capacity of the video project can be significantly reduced and the burden of transmission between electronic devices of users can be reduced. In addition, when content including personalized information is shared, it is possible to prevent leakage of privacy in advance.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF DRAWINGS

FIG. 1 is a diagram illustrating an electronic device to which various embodiments of the present disclosure are applied.

FIG. 2 is a diagram illustrating a system hierarchy structure of an electronic device to which various embodiments of the present disclosure are applied.

FIG. 3 is a flowchart illustrating a video editing method to which various embodiments of the present disclosure are applied.

FIG. 4 is a diagram illustrating an editing UI provided by a video editing UI control apparatus according to various embodiments of the present disclosure.

FIGS. 5A to 5E are diagrams illustrating a clip editing UI provided by a video editing UI according to various embodiments of the present disclosure.

FIG. 6 is a diagram of a configuration of an electronic device which serves to share content using dummy media according to an embodiment of the present disclosure, as an electronic device capable of editing content.

FIG. 7 is a flowchart of a content sharing method using dummy media according to another embodiment of the present disclosure.

FIGS. 8A and 8B are diagrams illustrating creation of dummy media according to the process of FIG. 7.

FIG. 9 is a flowchart of a content sharing method using dummy media according to another embodiment of the present disclosure.

FIG. 10 is a diagram illustrating replacement of alternative media according to the process of FIG. 9.

### MODE FOR INVENTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

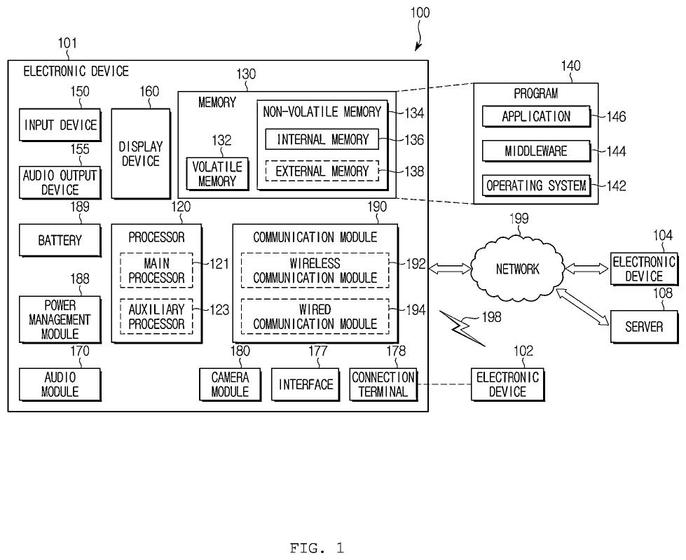

Various embodiments of the present disclosure may be implemented in an electronic device including a communication module, a memory, a display device (or display), and a processor, and an editable content sharing device according to an embodiment of the present disclosure may be implemented by an electronic device (e.g., 101, 102, and 104 in FIG. 1) having an editing application embedded therein. According to the present disclosure, the electronic device may be a type of computing device according to the present disclosure. For convenience of description, in the present disclosure, an editing application is described as an example of a content editing application or a video (or image) editing application. Content may include not only videos and images, but also various types of media objects, such as audio, voice, music, text, and graphics. Also, the editable device may be implemented by an electronic device having an image processing unit and a controller capable of processing videos (or images) and subtitle data.

Preferably, an electronic device to which various embodiments of the present disclosure are applied means a portable electronic device. The electronic device may be a user device, and the user device may be various types of devices such as, for example, a smartphone, a tablet PC, a laptop, and a desktop.

FIG. 1 is a block diagram illustrating an electronic device 101 in a network environment 100, as a diagram illustrating an electronic device to which various embodiments of the present disclosure are applied. Here, the electronic device 101 may be referred to as a computing device, and the electronic device 101 may have a built-in content editing application or an application downloaded from the outside and installed therein.

Referring to FIG. 1, in the network environment 100, the electronic device 101 communicates with an electronic device 102 through a first network 198 (e.g., short-range wireless communication), or communicate with an electronic device 104 or a server 108 through a second network 199 (e.g., a long-distance wireless communication). According to an embodiment, the electronic device 101 may communicate with the electronic device 104 through the server 108. According to an embodiment, the electronic device 101 may include a processor 120, a memory 130, an input device 150, an audio output device 155, a display device 160, an audio module 170, and an interface 177, a camera module 180, a power management module 188, a battery 189, a communication module 190 for transmitting and receiving data through networks 198 and 199, and the like. In another embodiment, in the electronic device 101, at least one of these components (e.g., the display device 160 or the camera module 180) may be omitted or another component may be added.

The processor 120 may, for example, drive software (e.g., program 140) to control at least one other component (e.g., hardware or software component) of the electronic device 101 connected to the processor 120 and perform various data processing and calculations. The processor 120 may load and process commands or data received from another component (e.g., the communication module 190) into a volatile memory 132, and store resultant data in a non-volatile memory 134. According to an embodiment, the processor 120 may include a main processor 121 (e.g., a central processing unit or an application processor) and an auxiliary processor 123 that operates independently of the main processor 121. For example, the auxiliary processor 123 may be additionally or alternatively mounted on the main processor 121 to use less power than the main processor 121. As another example, the auxiliary processor 123 may include an auxiliary processor 123 (e.g., a graphic processing unit, an image signal processor, a sensor hub processor, or a communication processor) specialized for a designated function. Here, the auxiliary processor 123 may be operated separately from or embedded in the main processor 121.

In this case, the auxiliary processor 123 may, for example, control at least some of functions or states related to at least one (e.g., the display device 160 or the communication module 190) of the components of the electronic device 101 in place of the main processor 121, while the main processor 121 is in an inactive (e.g., sleep) state. As another example, while the main processor 121 is in an active (e.g., application execution) state, the auxiliary processor 123, along with the main processor 121, may control at least some of functions or states related to at least components of the electronic device 101.

According to an embodiment, the auxiliary processor 123 (e.g., an image signal processor or a communication processor) may be implemented as a part of another functionally related component (e.g., the camera module 180 or the communication module 190). The memory 130 may store various data, for example, software (e.g., program 140), used by at least one component of the electronic device 101 (e.g., the processor 120) and input data or output data for commands related thereto. The memory 130 may include a volatile memory 132 or a non-volatile memory 134. The non-volatile memory 134 may be, for example, an internal memory 136 mounted in the electronic device 101 or an external memory 138 connected through an interface 177 of the electronic device 101. Original media, such as images captured by the camera module 180 and images obtained from the outside, video projects created through editing applications, and related data are allocated to and stored in at least one some areas of the internal and/or external memories 136 and 138 by settings of the electronic device 101 or according to user requests.

The program 140 is software stored in the memory 130, and may include, for example, an operating system 142, middleware 144, or an application 146. The application 146 may include a plurality of software for various functions, and may have a content editing application according to the present disclosure. The editing application is executed by the processor 140 and may be software that creates and edits a new video or selects and edits an existing video. In this disclosure, the application 146 is described separately from the program 140. However, since the operating system 142 and the middleware 144 are generally regarded as a kind of program that generally controls the electronic device 101, the program 140 may be commonly used without distinction from the application 146 from a narrow point of view. For convenience of description, a computer program that implements a content sharing method using dummy media according to the present disclosure may be referred to as an application 146, and in the present disclosure, the program 140 may be used interchangeably with the application for performing the content sharing method from a narrow point of view.

The input device 150 is a device for receiving a command or data to be used in a component (e.g., the processor 120) of the electronic device 101 from the outside (e.g., a user) of the electronic device 101, and may include, for example, a microphone, a mouse or a keyboard.

The audio output device 155 may be a device for outputting a sound signal to the outside of the electronic device 101. For example, the audio output device 155 may include a speaker used for general purposes such as playing multimedia or recording, and a receiver used exclusively for receiving calls. According to one embodiment, the receiver may be formed integrally with or separately from the speaker.

The display device 160 may be a display (or display device) for visually providing information to the user of the electronic device 101. The display device 160 may include, for example, a screen provision device for two-dimensionally displaying an image, a hologram device, or a projector and a control circuit for controlling the device. According to an embodiment, the display device 160 may function not only as an image output interface but also as an input interface for receiving user input. The display device 160 may include, for example, a touch circuitry or a pressure sensor capable of measuring the strength of a touch pressure. The display device 160 may detect the coordinates of a touch input area, the number of touch input areas, a touch input gesture, etc. based on the touch circuitry or the pressure sensor, and transmit the detected result to the main processor 121 or the auxiliary processor 123.

The audio module 170 may convert bidirectionally sound and electrical signals. According to an embodiment, the audio module 170 may obtain sound through the input device 150 or output sound through an external electronic device (e.g., an electronic device 102 (e.g., speaker or headphone)) connected to the electronic device 101 by wire or wirelessly.

The interface 177 may support a designated protocol capable of connecting to an external electronic device (e.g., the electronic device 102) by wired or wirelessly. According to one embodiment, the interface 177 may include a high definition multimedia interface (HDMI), a universal serial bus (USB) interface, an SD card interface, or an audio interface.

A connection terminal 178 is a connector capable of physically connecting the electronic device 101 and the external electronic device (e.g., the electronic device 102), for example, an HDMI connector, a USB connector, an SD card connector, or an audio connector (e.g., headphone connector).

The camera module 180 may capture images and videos. According to one embodiment, the camera module 180 may include one or more lenses, image sensors, image signal processors, or flashes.

The power management module 188 is a module for managing power supplied to the electronic device 101, and may be configured as at least a part of a power management integrated circuit (PMIC).

The battery 189 is a device for supplying power to at least one component of the electronic device 101, and may include, for example, a non-rechargeable primary battery, a rechargeable secondary battery, or a fuel cell.

The communication module 190 may support establishment of a wired or wireless communication channel between the electronic device 101 and the external electronic device (e.g., the electronic device 102, the electronic device 104, or the server 108) and performance of data communication through the established communication channel. The communication module 190 may include one or more communication processors that support wired communication or wireless communication that are operated independently of the processor 120 (e.g., an application processor). According to an embodiment, the communication module 190 includes a wireless communication module 192 (e.g., a cellular communication module, a short-range wireless communication module, or a global navigation satellite system (GNSS) communication module) or a wired communication module 194 (e.g., a local area network (LAN) communication module or a power line communication module), and, using a corresponding communication module among them, may communicate with the external electronic device through a first network 198 (e.g., a short-range communication network such as Bluetooth, Bluetooth low energy (BLE), Wi-Fi direct, or infrared data association (IrDA)) or a second network 199 (e.g., a long-distance network such as a cellular network, the Internet, or a computer network (e.g., LAN or WAN)). The above-described various types of the communication modules 190 may be implemented as a single chip or may be implemented as separate chips.

Some of the above components may be connected to each other through a communication method between peripheral devices (e.g., a bus, GPIO (general purpose input/output), SPI (serial peripheral interface), or MIPI (mobile industry processor interface)) to exchange signals (e.g. commands or data) with each other.

According to an embodiment, commands or data may be transmitted or received between the electronic device 101 and the external electronic device 104 through the server 108 connected to the second network 199. Each of the electronic devices 102 and 104 may be the same as or different from the electronic device 101. According to an embodiment, at least some of the operations executed in the electronic device 101 may be executed in another or a plurality of external electronic devices. According to an embodiment, when the electronic device 101 needs to perform a specific function or service automatically or upon request, the electronic device 101 may request at least some functions associated with the function or service from the external electronic device instead of or additional to executing the function or service by itself. The external electronic device, which has received the request, may execute the requested function or additional function and deliver the result to the electronic device 101. The electronic device 101 may provide the requested function or service by processing the received result without change or additionally. To this end, for example, cloud computing, distributed computing, or client-server computing technology may be used.

The server 108 may transmit a content editing application according to the request of the electronic device 101 and control the electronic device 101 to implement the application. When the application is executed, the server 106 may exchange data with the electronic device 101, and support the electronic device 101 to perform the content sharing method using dummy media according to the present disclosure. In this regard, the server 106 may be a type of computing device according to the present disclosure.

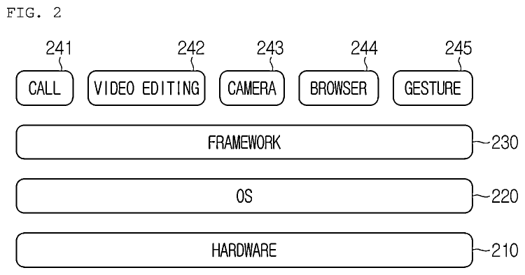

FIG. 2 is a diagram for explaining a system hierarchy structure of an electronic device to which various embodiments of the present disclosure are applied.

Referring to FIG. 2, an electronic device 200 may include a hardware layer 210 corresponding to the electronic device 101 of FIG. 1 described above, and an operating system (OS) layer 220 that manages the hardware layer 210 as a higher layer of the hardware layer 210, a framework layer 230 as a higher layer of the OS layer 220, and application layers 241 to 245.

The OS layer 220 controls overall operations of the hardware layer 210 and performs a function of managing the hardware layer 210. That is, the OS layer 220 is in charge of basic functions such as hardware management, memory, and security. The OS layer 220 may include drivers for operating or driving hardware devices included in the electronic device, such as a display driver for driving a display device, a camera driver for driving a camera module, and an audio driver for driving an audio module. In addition, the OS layer 220 may include a library and a runtime that developers may access.

The framework layer 230 exists as a higher layer of the OS layer 220, and the framework layer 230 serves to connect the application layers 241 to 245 and the OS layer 220. That is, the framework layer 230 includes a location manager, a notification manager, and a frame buffer for displaying an image on the display unit.

The application layers 241 to 245 implementing various functions of the electronic device 101 is located above the framework layer 230. For example, the application layers 241 to 245 may include various application programs such as a call application 241, a video editing application 242, a camera application 243, a browser application 244, and a gesture application 245.

Furthermore, the OS layer 220 may provide a menu or UI capable of adding or deleting at least one application or application program included in the application layers 241 to 245, and through this, at least one application or application program included in the application layers 241 to 245 may be added or deleted by the user. For example, as described above, the electronic device 101 of FIG. 1 may be connected to the other electronic devices 102 and 104 or the server 108 through communication, and may receive data (that is, at least one application or application program) provided from the other electronic devices 102 and 104 or the server 108 by the request of the user and store it in the memory. At this time, at least one application or application program stored in the memory may be configured and operated in the application layers 241 to 245. In addition, at least one application or application program may be selected by the user using the menu or UI provided by the OS layer 220, and the selected at least one application or application program may be deleted.

Meanwhile, when a user control command input through the application layers 241 to 245 is input to the electronic device 101, it may be transferred from the application layers 241 to 245 to the hardware layer 210 to execute a specific application corresponding to the input control command, and the result may be displayed on the display device 160.

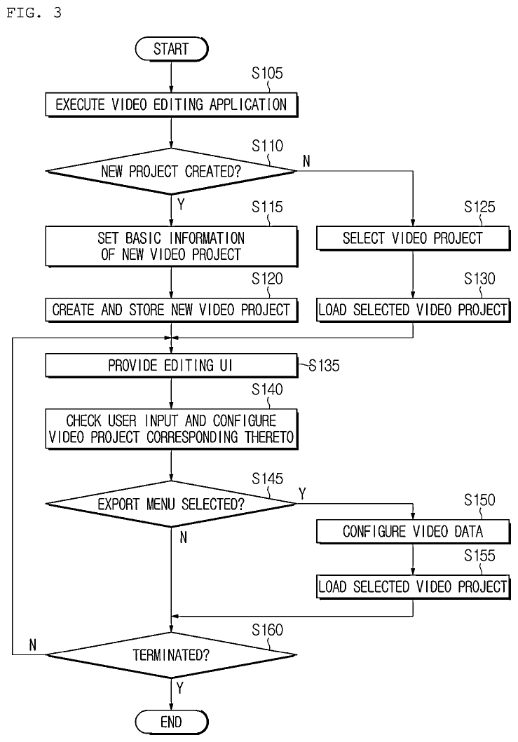

FIG. 3 is a flowchart illustrating a video editing method to which various embodiments of the present disclosure are applied. In FIG. 3, the content editing application is described as a video editing application.

Referring to FIG. 3, first, the video editing method may be operated by the above-described electronic device (or computing device), and the operation may be initiated as a video editing application is selected and executed by user input (S105).

When the video editing application is executed, the electronic device may output an initial screen of the video editing application to a display device (e.g., a display). A menu (or UI) for creating a new video project and a video project selection menu (or UI) for selecting a video project being edited in advance may be provided on the initial screen. On this initial screen, when the menu (or UI) for creating the new video project is selected by the user, the process may proceed to step S115, and when the video project selection menu (or UI) is selected, the process may proceed to step S125 (S110).

In step S115, the electronic device 101 may provide a menu (or UI) for setting basic information of a new video project, and set and apply the basic information input through the menu (or UI) to the new video project. For example, the basic information may include an aspect ratio of the new video project. Based on this, the electronic device may provide a menu (or UI) capable of selecting an aspect ratio such as 16:9, 9:16, 1:1, etc., and an aspect ratio input through the menu (or UI) may be set and applied to the new video project.

Thereafter, the electronic device 101 may create a new video project by reflecting the basic information set in step S115, and store the created new video project in a storage medium (S120).

Although the aspect ratio is exemplified as basic information in embodiments of the present disclosure, the present disclosure is not limited thereto, and may be variously changed by a person having ordinary knowledge in the technical field of the present disclosure. For example, the electronic device 101 may provide a menu (or UI) capable of setting at least one of automatic control of a master volume, the size of the master volume, audio fade-in default setting, audio fade-out default settings, video fade-in default settings, video fade-out default settings, default settings of an image clip, default settings of a layer length or pan & zoom default settings of the image clip, and a value input through the menu (or UI) may be set as the basic information of the new video project.

As another example, the electronic device 101 may automatically set the aspect ratio, automatic control of the master volume, the size of the master volume, the audio fade-in default settings, the audio fade-out default settings, the video fade-in default settings, the video fade-out default settings, the default settings of the image clip, the default settings of the layer length, and the pan & zoom default settings of the image clip to predetermined values. In addition, the electronic device 101 may provide a setting menu (or UI), receive control values of the aspect ratio, automatic control of the master volume, the size of the master volume, the audio fade-in default settings, the audio fade-out default settings, the video fade-in default settings, the video fade-out default settings, the default settings of the image clip, the default settings of the layer length, and the pan & zoom default settings of the image clip through the setting menu (or UI), and set the above-described default information according to the received values.

Meanwhile, in step S115, the electronic device 101 may provide a project list including video projects stored in a memory 130 and provide an environment in which at least one video project included in the project list may be selected. Through the above-described environment, the user may select at least one video project included in the project list (S130), and the electronic device 101 may load the at least one video project selected by the user (S135).

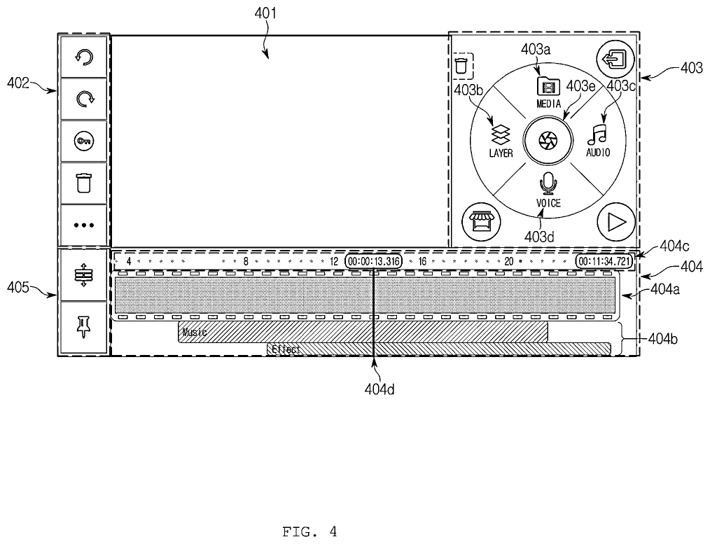

In step S135, the electronic device 101 may provide an editing UI. As shown in FIG. 4, the editing UI may include a video display window 401, a media setting window 402, a media input window 403, a clip display window 404, a clip setting window 405, and the like. In the editing UI, the video display window, the media setting window, and the media input window may be displayed on an upper portion of the display, and the clip display window and the clip setting window may be displayed on a lower portion of the display.

The media setting window may include an export menu, a capture menu, a setting menu, and the like, and the export menu, the capture menu, and the setting menu may be provided in the form of icons or text capable of recognizing the corresponding menu.

The media input window may include a media input menu 403a, a layer input menu 403b, an audio input menu 403c, a voice input menu 403d, a shooting menu 403e, and the like, and the media input menu 403a, the layer input menu 403b, the audio input menu 403c, the voice input menu 403d, and the shooting menu 403e may be provided in the form of icons or text capable of recognizing the corresponding menu. Also, each menu may include a sub-menu, and as each menu is selected, the electronic device 101 may compose and display a sub-menu corresponding thereto.

For example, the media input menu 403a may be connected to the media selection window as a sub-menu, and the media selection window may provide an environment capable of selecting media stored in the memory 130, for example, original media created by the user and received from another source. Media selected through the media selection window may be inserted and displayed in the clip display window. The electronic device 101 may check the type of media selected through the media selection window, set the clip time of the media in consideration of the checked type of the media, insert and display it in the clip display window. Here, the type of media may include images, videos, and the like. If the type of media is an image, the electronic device 101 may check a default length setting value of the image clip and set an image clip time according to the default length setting value of the image clip. In addition, if the type of media is a video, the electronic device 101 may set the time of the video clip according to the length of the corresponding media.

As a sub-menu of the layer input menu 403b, a media input menu, an effect input menu, an overlay input menu, a text input menu, a media input menu, and a drawing input menu may be included.

The media input menu may be configured in the same way as the aforementioned media input menu.

The effect input menu may provide an environment in which blur effect, mosaic effect, noise effect, sandstorm effect, melting point effect, crystal effect, star filter effect, display board effect, haze effect, fisheye lens effect, magnifying lens effect, flower twist effect, night vision effect, sketch effect, etc. may be selected. An effect selected through the effect input menu may be inserted and displayed in the clip display window. At this time, the electronic device may check the default setting value of the layer length and set the effect clip time according to the default setting value of the layer length.

The overlay input menu may provide an environment in which stickers and icons of various shapes or shapes may be selected. The stickers, icons, etc. selected through the overlay input menu may be inserted and displayed in the clip display window. At this time, the electronic device may check the default setting value of the layer length and set the clip times of stickers, icons, etc. according to the default setting value of the layer length.

The text input menu may provide an environment in which text may be input, for example, a Qwerty keyboard. The text input through the text input menu may be inserted and displayed in the clip display window. At this time, the electronic device may check the default setting value of the layer length and set the text clip time according to the default setting value of the layer length.

The drawing input menu may be configured to provide a drawing area in the image display window and to display a drawing object in a touch input area in the image display window. The handwriting input menu may include a drawing tool selection menu for selecting a drawing tool, a color selection menu for selecting a drawing color, a thickness setting menu for setting the thickness of a drawing object, a partial deletion menu for deleting a created drawing object, and a delete-all menu for deleting all drawn objects as sub-menus. In addition, when the handwriting input menu is selected, the electronic device may check the default setting value of the layer length and set the drawing object clip time according to the default setting value of the layer length.

The audio input menu 403c may be connected to the audio selection window as a sub-menu, and the audio selection window may provide an environment in which an audio file stored in a storage medium may be selected. An audio file selected through the audio selection window may be inserted and displayed in the clip display window.

The voice input menu 403d may be a menu for recording sound input through a microphone. When the voice input menu is selected by the user, the electronic device may activate the microphone provided in the device to detect a voice signal input through the microphone. In addition, the electronic device may display a recording start button, and when the recording start button is input, recording of the voice signal may be started. Furthermore, the electronic device may visualize and display the voice signal input through the microphone. For example, the electronic device may check the amplitude or frequency characteristics of the voice signal and display the checked characteristics in the form of a level meter or a graph.

The shooting menu 403e may be a menu for capturing an image or video input through a camera module included in the electronic device 101. The shooting menu 403e may be displayed through an icon visualizing a camera device. The shooting menu 403e may include an image/video shooting selection menu for selecting a camera for capturing an image or a camcorder for capturing a video as a sub-menu thereof. Based on this, when the shooting menu 403e is selected by the user, the electronic device may display an image/video shooting selection menu. In addition, the electronic device may activate an image capturing mode or a video capturing mode of the camera module according to selection through the image/video capturing selection menu.

The clip display window 404 may include at least one clip line displaying a clip corresponding to media, effect, overlay, text, drawing, audio, voice signal, etc. input through the media input window.

The clip line may include a main clip line 404a and a sub clip line 404b, and a clip line provided at the uppermost end of the clip display window is referred to as the main clip line 404a, and at least one clip line provided under the main clip line 404a may be referred to as the sub clip line 404b.

The electronic device may fix and display the main clip line 404a at the uppermost end of the clip display window, check drag input based on an area where the sub clip line 404b exists, and scroll the sub clip line 404b up and down according to a drag input direction.

Furthermore, when the drag input direction is checked as an upward direction, the electronic device 101 may move and display the sub clip line 404b to an upper area, and when the drag input direction is checked as a downward direction, the electronic device may move and display the sub clip line 404b to a lower area. In addition, the electronic device may display the height of the main clip line 404a differently according to the movement of the sub clip line 404b. For example, when the sub clip line 404b moves upward, the height of the main clip line 404a may be decreased and displayed, and when the sub clip line 404b moves downward, the height of the main clip line 404a may be increased and displayed.

In particular, the clip display window 404 may include a time display line 404c indicating the time of the video project and a play head 404d. The time display line 404c may be displayed above the main clip line 404a described above, and may include a scale or number in a predetermined unit. In addition, the play head 404d may be displayed as a line starting from the time display line 404c and vertically connected to the lower end of the clip display window, and may be displayed in a color (e.g., red) that can be easily recognized by the user.

Furthermore, the play head 404d may be provided in a fixed form in a predetermined area, and the objects included in the main clip line 404a and the sub clip line 404b provided in the clip display window and the time display line 404c may be configured to be movable in the left and right directions.

For example, when drag input is generated in the left and right directions in an area where the main clip line 404a, the sub clip line 404b, and the time display line 404c are located, the electronic device may move and display the objects included in the main clip line 404a and the sub clip line 404b and the time display line 404c in the left and right directions. In this case, the electronic device may be configured to display a frame or object corresponding to the play head 404d in the image display window. In addition, the electronic device 101 may check a detailed time (e.g., in units of 1/1000 second) that the play head 404d touches, and display the checked detailed time together in the clip display window.

In addition, the electronic device 101 may check whether a multi-touch has occurred in the clip display window 404, and if a multi-touch has occurred, a scale or number of a predetermined unit included in the time display line 404c may be changed and displayed in response to the multi-touch. For example, when input in which a multi-touch interval gradually decreases is confirmed, the electronic device may decrease the interval between scales or numbers. When input in which the multi-touch interval gradually increases is confirmed, the electronic device may increase and display the interval between scales or numbers.

The electronic device may configure the clip display window 404 so that a clip displayed on the clip line may be selected, and when a clip is selected, it may visualize and display that the corresponding clip has been selected. For example, when selection of a clip is detected, the electronic device may provide a clip selector to a boundary of the selected clip, and the clip selector may be displayed in a predetermined color, for example, yellow.

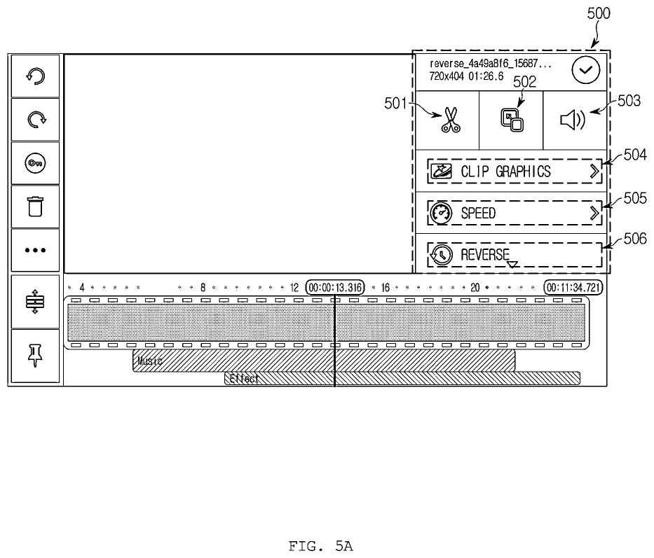

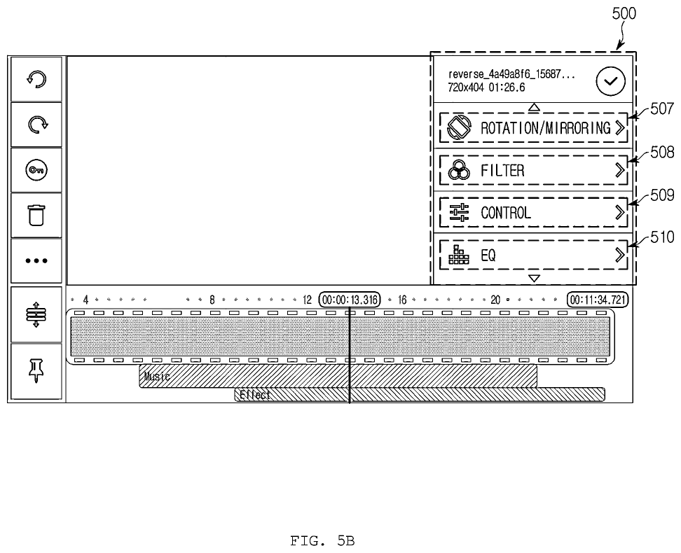

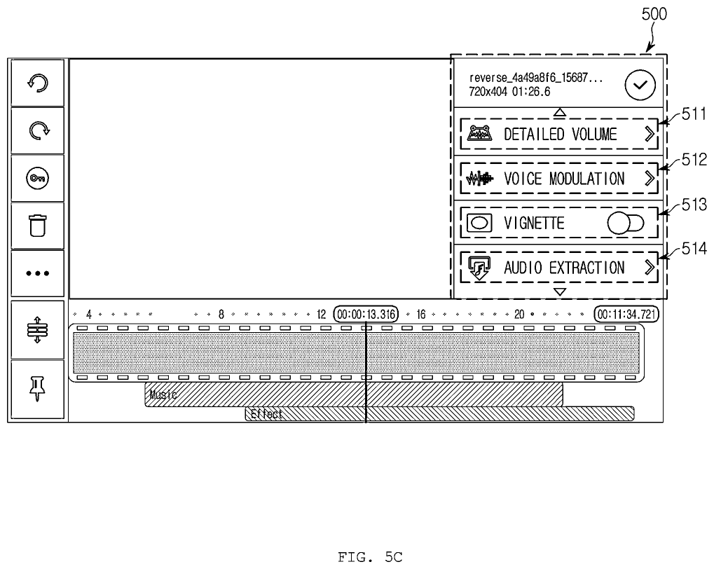

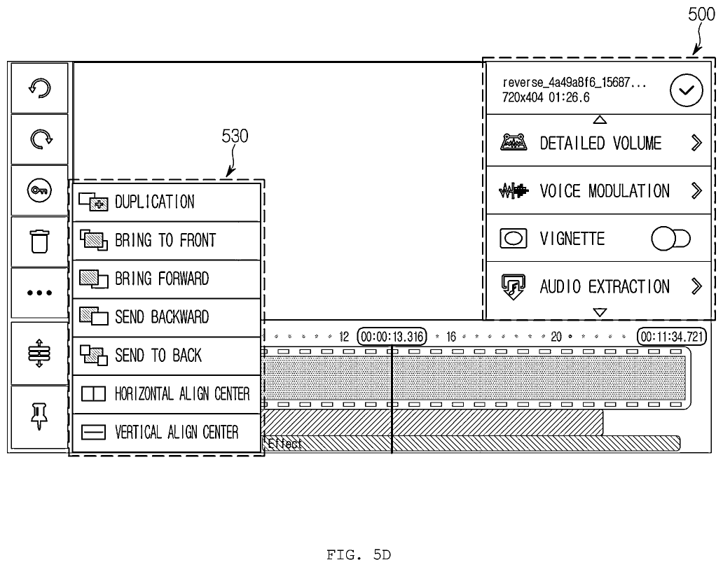

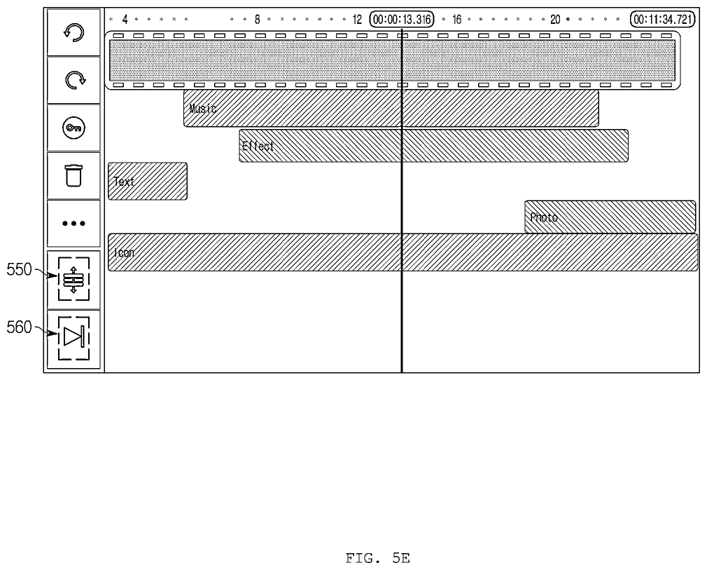

Preferably, when selection of a clip is detected, the electronic device may provide a clip editing UI capable of editing the selected clip. For example, the electronic device may display a clip editing UI in an area where the media input window 403 exists, as shown in FIGS. 5A to 5D. The clip editing UI may be set differently according to the type of the selected clip. Specifically, when the type of clip is a video clip, the electronic device may configure and provide a clip editing UI 500, by including a trim/split menu 501, a pan/zoom menu 502, an audio control menu 503, a clip graphic menu 504, and a speed control menu 505, a reverse control menu 506, a rotation/mirroring control menu 507, a filter menu 508, a brightness/contrast control menu 509, a voice EQ control menu 510, a detailed volume control menu 511, a voice modulation menu 512, a vignette control menu 513, an audio extraction menu 514, and the like.

The clip editing UI for each type of clip may be configured based on the structure of the video editing UI.

Additionally, the electronic device 101 may further display a clip editing expansion UI 530 in an area where the media setting window exists. The clip editing expansion UI displayed in the area of the media setting window may also be set differently according to the type of the selected clip. For example, when the type of clip is a video clip, an image clip, an audio clip, or an audio signal clip, the electronic device may configure and provide the clip editing expansion UI 530 by including a clip deletion menu, a clip duplication menu, a clip layer duplication menu, and the like. If the type of clip is a video clip, image clip, audio clip, or audio signal clip, the electronic device may configure and provide the clip editing expansion UI 530 by including the clip deletion menu, the clip duplication menu, the clip layer duplication menu, and the like, and if it is an effect clip, text clip, overlay clip, or drawing clip, the electronic device may configure and provide the clip editing expansion UI by including a clip deletion menu, a clip duplication menu, a bring-to-front menu, a bring-forward menu, a send-backward menu, a send-to-back menu, a horizontal align center menu, a vertical align center menu and the like.

The clip setting window may include a clip enlargement display menu 550 and a clip movement control menu 560, as shown in FIG. 5E. When the clip display menu 550 is selected by the user, the electronic device may enlarge and display the clip display window to the entire area of the display. Also, when the clip movement control menu 560 is selected, the electronic device may move and display the clip according to the play head. Furthermore, the clip movement control menu 560 may include a start area movement menu or an end area movement menu, and it is preferable that the start area movement menu or end area movement menu may be adaptively displayed in consideration of the position of the play head touching the clip. For example, the electronic device basically provides the start area movement menu, and when a clip touches a starting position of the play head, the start area movement menu may be replaced with the end area movement menu and displayed.

In step S140, the electronic device may check user input input through the editing UI, configure a video project corresponding to the user input, and store the configured video project in a storage medium.

As described above, the editing UI is configured to include an export menu in the media setting window. When the export menu is selected by the user (Y in S145), the electronic device 101 may configure video data by reflecting the information configured in the video project and store it in a memory 130 (S150).

In addition, the electronic device 101 may upload the edited video and project to a shared video service-related device according to the request of a user at the same time as or after the video data is stored through the export menu. In the content sharing method using dummy media according to embodiments of the present disclosure, when sharing a project including an edited video, the project may be configured to include dummy media and dummy media information. In addition, another electronic device that has obtained the shared project may execute a predetermined process on alternative media desired by other users by referring to dummy media information through a video editing application, replace the dummy media with the processed alternative media, and edit it.

The structure of the editing UI provided by the apparatus for controlling the video editing UI according to various embodiments of the present disclosure may be configured as follows.

First of all, as shown in FIG. 4, the editing UI may basically include a video display window 401, a media setting window 402, a media input window 403, a clip display window 404, a clip setting window 405, and the like. At least one clip selected through the media input window 403 may be displayed on the clip display window 404. In addition, as at least one clip 404a or 404b included in the clip display window 404 is selected, as shown in FIGS. 5A to 5D, clip editing menus 501 to 514 may be provided in the area where the media input window 403 exists. At this time, the clip editing menus 501 to 514 may be provided adaptively according to the structure of the editing UI for each clip type.

The video clip editing menu may include a trim/split menu, a pan/zoom menu, an audio control menu, a clip graphic menu, a speed control menu, a reverse control menu, a rotation/mirroring menu, a filter menu, a brightness/contrast/gamma control menu, a voice EQ control menu, a detailed volume control menu, a voice modulation control menu, a vignetting ON/OFF control menu, an audio extraction menu, and the like.

The trim/split menu may include a trim menu on the left of the play head, a trim menu on the right of the play head, a split menu on the play head, a still image split and insert menu, and the like, as sub-menus.

The audio control menu may include a master volume control bar, a sound effect volume control bar, an automatic volume ON/OFF menu, a left/right balance control bar, a pitch control bar, and the like, as sub-menus. In addition, the master volume control bar, the sound effect volume control bar, the left/right balance control bar, the pitch control bar, and the like may be set to support a detailed control UI, and the master volume control bar, the sound effect volume control bar, the left/right balance control bar, the pitch control bar and the like may be managed through the main editing UI. A UI set as the main editing UI may be configured to display a detailed control UI together. As another example, when touch input is generated for more than a predetermined time (e.g., 1 second) in an area where the main editing UI set to support the detailed control UI exists, the detailed control UI may be activated as a sub-menu.

The clip graphic menu may be configured to select at least one graphic to be inserted into the clip.

The speed control menu may include at least one predetermined speed control button (e.g., 1×, 4×, 8×), a speed control bar, a mute ON/OFF menu, a pitch maintenance ON/OFF menu, and the like. Also, the speed control bar may be managed as a main editing UI.

The reverse control menu may be configured to perform reverse processing of a video included in a corresponding clip.

The voice EQ control menu may be configured to select at least one voice EQ to be applied to a video.

The filter menu may be configured to select at least one video filter to be applied to the video.

The brightness/contrast/gamma control menu may include a brightness control bar, a contrast control bar, a gamma control bar and the like as sub-menus so as to control the brightness/contrast/gamma value of the video, and the brightness control bar, the contrast control bar, and the gamma control bar and the like may be managed as a main editing UI and set to support the detailed control UI.

The rotation/mirroring menu may include a horizontal mirroring menu, a vertical mirroring menu, a counterclockwise rotation menu, a clockwise rotation menu and the like as sub-menus, and the counterclockwise rotation menu and clockwise rotation menu may be managed as a main editing UI and set to support the detailed control UI.

The detailed volume control menu is a menu for controlling the volume of audio included in the video, and may include a control point addition menu, a control point deletion menu, a voice control bar and the like. The voice control bar may be managed as a main editing UI and set to support the detailed control UI.

The voice modulation control menu may be configured to select at least one voice modulation method to be applied to the video.

Meanwhile, the image clip editing menu may include a trim/split menu, a pan/zoom menu, a rotation/mirroring control menu, a clip graphic menu, a filter menu, a brightness/contrast/gamma control menu, a vignetting ON/OFF control menu, and the like.

In addition, the effect clip editing menu may include an effect setting menu, a transparency control menu, a trim/split menu, a rotation/mirroring control menu, and the like, and the trim/split menu, the rotation/mirroring control menu and the like may be configured similarly to the video clip editing menu. In addition, the effect setting menu and the transparency control menu may include an effect setting bar and a transparency control bar, respectively, as sub-menus, and the effect setting bar and the transparency control bar may be managed as a main editing UI and set to support the detailed control UI.

The overlay clip editing menu may include an overlay color setting menu, a transparency control menu, a trim/split menu, a rotation/mirroring control menu, a blending type setting menu, and the like. The trim/split menu, the rotation/mirroring control menu and the like may be configured similarly to the video editing menu. Also, the transparency control menu may include a transparency control bar as a sub-menu, and the transparency control bar may be managed as a main editing UI and set to support the detailed control UI.

In addition, the text clip editing menu may include a text font setting menu, a text color setting menu, a trim/split menu, a transparency control menu, a rotation/mirroring control menu, a text alignment method setting menu, a shadow ON/OFF menu, a glow ON/OFF menu, an outline ON/OFF menu, a background color ON/OFF menu, a blending type setting menu, and the like, and the trim/split menu, the transparency control menu, the rotation/mirroring control menu, and the like may be configured similarly to the video clip editing menu. In addition, the shadow ON/OFF menu, the glow ON/OFF menu, the outline ON/OFF menu, and the background color ON/OFF menu may respectively include a color control bar (e.g., R/G/B control bar) for setting a color or a transparency control bar for controlling transparency as sub-menus, and the color control bar (e.g., R/G/B control bar) or the transparency control bar may be managed as a main editing UI and set to support the detailed control UI.

In addition, the drawing clip editing menu may include a transparency control menu, a trim/split menu, a rotation/mirroring control menu, a blending type setting menu, and the like, and the trim/split menu, the rotation/mirroring control menu and the like may be configured similarly to the overlay clip editing menu. Also, the transparency control menu may include a transparency control bar as a sub-menu, and the transparency control bar may be managed as a main editing UI and set to support the detailed control UI.

In addition, the audio clip editing menu may include an audio control menu, a voice EQ control menu, a detailed volume control menu, a voice modulation control menu, a ducking ON/OFF control menu, a repeat ON/OFF control menu, a trim/split menu, and the like. The audio control menu, the voice EQ control menu, the detailed volume control menu, the voice modulation control menu, the trim/split menu, and the like may be configured similarly to a video clip editing menu.

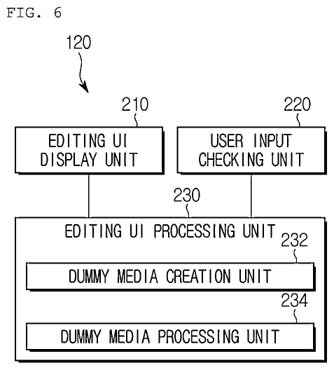

Hereinafter, with reference to FIG. 6, it will be mainly described that the electronic device 101 equipped with the video editing application 146 functions as an electronic device that shares content using dummy media according to embodiments of the present disclosure. For example, a video editing application may implement the above functions.

FIG. 6 is a diagram of a configuration of an electronic device which serves to share content using dummy media according to an embodiment of the present disclosure, as an electronic device capable of editing content.

Referring to FIG. 6, the electronic device 101 according to the present disclosure may include a processor (120 in FIG. 1) for executing content sharing using dummy media. The processor 120 may include an editing UI display unit 210, a user input checking unit 220, and an editing UI processing unit 230. The processor 120 may include the above-described members as hardware or software (logical) modules.

The editing UI display unit 210 may visualize and display the above-described editing UI on a display device 160 (e.g., a display), and may check and output a menu or UI, the output of which is requested by the editing UI processing unit 230, on the display device (see 160 of FIG. 1; e.g., a display).

Here, the editing UI may include at least one menu or UI having a predetermined shape and size, and at least one menu or UI may be located and displayed in a predetermined area.

The user input checking unit 220 may check user input information such as user input generation coordinates, types of user input and a gesture input direction, based on the coordinates of the area touch-input through the display device 160, the number of touch-input areas, and a touch-input gesture, etc., and provide the checked user input information to the editing UI processing unit 230. The type of user input may be, for example, single touch input, multi-touch input, single gesture input, or multi-gesture input. Gesture input may be single or multiple gestures, for example.

The editing UI processing unit 230 may check user input information provided by the user input checking unit 220 and process an operation corresponding to the user input information. For example, the editing UI processing unit 230 may check the user input generation coordinates, and check and process an operation corresponding to a menu or UI existing at the checked coordinates. As another example, the editing UI processing unit 230 may check a sub-menu or sub-UI of the menu or UI existing at the checked coordinates, and request output of the checked sub-menu or sub-UI to the editing UI display unit 210.

In addition, the editing UI processing unit 230 may include a dummy media creation unit 232 for creating dummy media and a dummy media processing unit 234 for performing processing to share a video project including dummy media according to a request and processing the dummy media of the shared video project.

The dummy media creation unit 232 may include a menu or UI for controlling creation of dummy media, and may include, for example, a UI for receiving whether or not to create dummy media. The UI for receiving whether or not to create dummy media may be output through the editing UI display unit 210 and may receive whether or not to create dummy media. The result of receiving whether or not to create dummy media is sent to the dummy media creation unit 232, and in response to this, the dummy media creation unit 232 may configure dummy media by detecting media included in the video project.

Here, the video project may include project configuration information related to content edited by a user through a video editing application. The project configuration information may include, for example, original media related to media objects (e.g., video, image, audio, voice, etc.) constituting edited content, individual media information of each object, media editing information assigned to media objects, editing elements for decorating media objects, for example, decorative editing information related to various effects and layers described above, and additional information (or meta data) with other various information recorded therein.

The dummy media creation unit 232 may detect information on at least one media included in the video project (hereinafter, referred to as ‘individual media information’) and generate dummy media information based on the individual media information. Here, the individual media information may include an identifier for identifying each media, a type of media, resolution of media, time information of media, and the like. The individual media information may also be referred to as configuration information of corresponding original media.

The type of media may include, for example, at least one of image, video, voice, or audio. The resolution of the media may include, for example, horizontal and vertical sizes of the media. Time information may include, for example, a start point of media, a duration of media, and an end point of media.

Furthermore, the dummy media creation unit 232 may generate dummy media information for all at least one media included in the video project, or configure dummy media information for selected media among at least one media included in the video project.

Considering the foregoing, the dummy media creation unit 232 may activate and display a UI capable of receiving whether to create dummy media, in an operation of creating a video project or an operation of creating media included in the video project.

In the present disclosure, in order to prevent a problem in which the capacity of the entire project file is excessively increased when the original media has a large capacity, the dummy media creation unit 232 may be configured to activate a UI capable of receiving whether to restrictively create dummy media for original media having a capacity greater than a threshold value. The UI may be implemented as a dummy media creation UI, for example.

As another example, when personalized information is included in media included in a video project, a user who has created the video project may not want the media containing the personalized information to be shared. The present disclosure is to prevent the above problem, and the dummy media creation unit 232 may be configured to restrictively activate a UI capable of receiving whether or not to create dummy media with respect to media containing personalized information.

The dummy media creation unit 232 may check whether personalized information is contained in the edited media object. Taking a video or image as an example in relation to checking, it may be checked whether an object similar to an object existing in another project or other media stored in the memory 130 or a cloud server used by a user is included. Here, the object may be, for example, a human face, an animal or plant, a unique object, and checking may be performed by an image comparison method using feature points between the objects. As another example, it may be checked whether an object existing in an individual media of a project to be shared includes a human face, an animal and plant possessed by or located near a person, or a unique object.

The dummy media creation unit 232 may configure the corresponding media as dummy media in consideration of the dummy media information. The dummy media does not contain original media, includes only dummy media formats, and may be composed of media objects of the same type as original media. In addition, the dummy media creation unit 232 may perform processing to include dummy media information and dummy media in a video project, when dummy media is used.

Meanwhile, the dummy media processing unit 234 may process the video project including the dummy media and dummy media information according to a user request or a request according to settings of a video editing application. In this case, the video project to be shared may be processed to include project configuration information excluding the original media replaced with the dummy image.

In addition, the dummy media processing unit 234 may check dummy media information included in the video project when another user's video project is shared and acquired through a video editing application, and provide a menu or UI capable of modifying the media included in the video project to alternative media based on the dummy media information.

For example, the dummy media processing unit 234 may check whether dummy media information is included in the video project. If dummy media information is included, the dummy media processing unit 234 may configure and provide a UI (an alternative media selection UI or a dummy media replacement UI, used interchangeably below) for selecting alternative media capable of replacing the dummy media. The alternative media selection UI may be configured to provide a list of media usable as alternative media and to allow the user to select at least one alternative media from the provided list. The list of media may be configured by listing media stored in the shared user's electronic device 101 or a cloud server.

As another example, the dummy media processing unit 234 may configure a list of media based on the type of media, resolution of the media, time information of the media, and the like., which are included in the dummy media information. For example, the dummy media processing unit 234 may configure a list of media by extracting only media having the type of media type, resolution of the media, time information of the media, etc. that match the dummy media information. The extracted media may be media that is stored in the shared user's electronic device 101 and identified as appropriate.

As another example, the dummy media processing unit 234 may configure a list of alternative media by extracting alternative media of the same or similar type based on the type of dummy media. As another example, the dummy media processing unit 234 may configure a list of media by extracting alternative media that is the same based on the time information of the dummy media or set within a predetermined time range.

When media selected by the sharing user or closely satisfying the above criteria does not match at least one of information constituting the dummy media information, the dummy media processing unit 234 may control and configure alternative media.

For example, although the type of media set in the dummy media and the type of alternative media are the same as videos, the time information of the media may not be the same. Specifically, when first time information of media set in the dummy media is greater than second time information set in alternative media, the dummy media processing unit 234 may control output of the alternative media. In this case, the dummy media processing unit 234 may, for example, control the last scene of the alternative media to be output until a final time. As another example, the dummy media processing unit 234 may control the alternate media to be repeatedly output until the final time.

As another example, when the first time information of the media set in the dummy media is smaller than the second time information set in the alternative media, the dummy media processing unit 234 may cut the alternative media with reference to the first time information. In this case, the dummy media processing unit 234 may cut the front or rear end of the alternative media according to user's selection or application setting. As another example, the dummy media processing unit 234 may generate alternative media having the first time information or edit such alternative media, by cutting the front and rear end of the alternative media based on the first time information according to the user's selection or application setting.

Meanwhile, the type of the media set in the dummy media and the type of the alternative media may not be the same. In this case, the dummy media processing unit 234 may control and configure the alternative media. For example, when the type of the dummy media is an image and the type of the alternative media is a video, the dummy media processing unit 234 may extract the first or last scene of the alternative media according to a user's request or application setting and configures it as alternative media. As another example, the dummy media processing unit 234 may configure alternative media by selectively extracting one scene from among a plurality of scenes included in the alternative media according to a user's request or application setting. For the user's selection, the dummy media processing unit 234 may configure and provide a UI capable of selecting a scene included in the alternative media.

Meanwhile, the resolution of the dummy media and the resolution of the alternative media may not be the same. In this case, the dummy media processing unit 234 may control and configure the resolution of alternative media. For example, when the first resolution of the dummy media is greater than the second resolution of the alternative media, the dummy media processing unit 234 may up-sample and configure the alternative media so that the second resolution of the alternative media matches the first resolution of the dummy media. On the other hand, when the first resolution of the dummy media is smaller than the second resolution of the alternative media, the dummy media processing unit 234 may down-sample and configure the alternative media so that the second resolution of the alternative media matches the first resolution of the dummy media.

As another example in which the resolutions of the dummy and alternative media are not the same, the dummy media processing unit 234 may perform control to adjust the horizontal and vertical size of the alternative image while maintaining the resolution of alternative media without transcoding to change the resolution of the alternative media according to a user's request or application setting. For example, when at least one of the horizontal or vertical sizes of the dummy media is smaller than that of the alternative media, the dummy media processing unit 234 may configure alternative media by cutting a portion of a spatial area having a large length in the alternative media without changing the resolution of the alternative media. For the user's selection, the dummy media processing unit 234 may provide a UI for allowing the user to select a spatial area to be maintained in the alternative media.

As another example, the dummy media processing unit 234 may provide an additional window for displaying a spatial area exceeding the size of the dummy media so that the spatial area having a large length in the alternative media can be viewed without changing the resolution of the alternative media.

As another example, when at least one of the horizontal and vertical sizes of the dummy media is greater than that of the alternative media, the dummy media processing unit 234 may configure alternative media, by enlarging a spatial area having a short size of original media to match the size of the dummy media, while maintaining the resolution of the original media related to the alternative media according to a user's request or application setting.

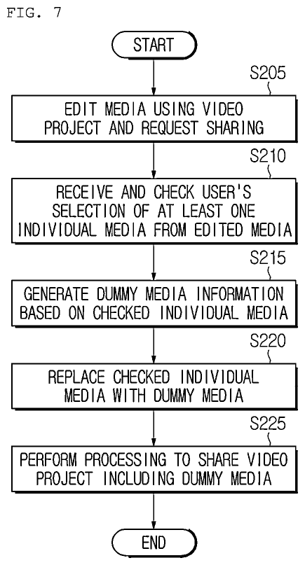

Hereinafter, a content sharing method using dummy media according to other embodiments of the present disclosure will be described with reference to FIGS. 7 to 10.

In the present disclosure, the video editing application 146 built in the electronic device 101 is described as executing the content sharing method, for example. In addition, the edited media, individual media, dummy media, and alternative media will be described as at least one of a video or an image, for example.

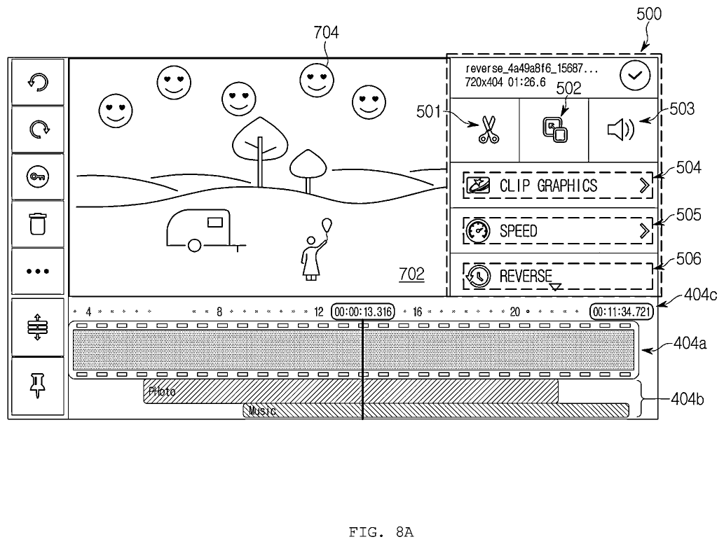

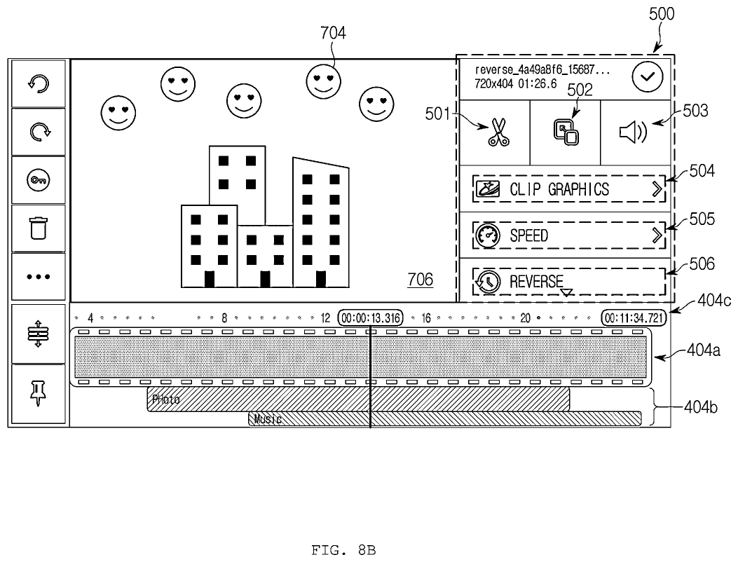

First, with reference to FIGS. 7 to 8B, in the content sharing method, a process of creating dummy media for content sharing will be described.

FIG. 7 is a flowchart of a content sharing method using dummy media according to another embodiment of the present disclosure. FIGS. 8A and 8B are diagrams illustrating creation of dummy media according to the process of FIG. 7.

The present disclosure may be performed by merging steps S135 to S145 of FIG. 3. In the present disclosure, for convenience of description, for example, the method may be performed after a user edits media through a video project and requests sharing of the video project including the edited media. Without being limited to the description of the present disclosure, embodiments of the present disclosure is applicable to various situations, such as during media editing, after editing is completed and before a request for sharing, or after storing a video project without a request for sharing, and receiving a user request for sharing. The method performed during media editing or before a request for sharing may be performed using, for example, the application such as a user interface separately provided with the editing UI display unit 201 and/or the dummy media creation unit 232. The user interface may be, for example, a dummy media creation UI provided in a predetermined area of the screen on which the video display window 401 and the clip display window 404 are displayed.

The sharing is performed by exchanging various information including a video project with social media such as YouTube, Instagram, and Facebook, or a sharing service operated by an editing application and a sharing space associated with various social services.

First, the user may edit original media selected by the user and request sharing, through the video display window 401, the clip display window 404, and various menus provided by the video editing application (S205).

Various examples of the editing are described through FIGS. 3 to 5e, and the selected media is exemplified as illustrated in FIG. 8A, and the media will be described as a video, for example. In FIG. 8A, the media selected by the user is denoted by reference numeral 702, and an effect element added to the media by the user through the application is denoted by reference numeral 704. The request for sharing may be initiated through a UI related to the request for sharing provided by the application.

Next, the dummy media creation unit 232 may receive and check the user's selection of at least one individual media from the edited media (S210).

Specifically, the dummy media creation unit 232 may provide a dummy media creation UI to the user through the editing UI display unit 210 in response to a request for sharing. The dummy media creation UI may include a menu or UI for inquiring whether to create dummy media and controlling the creation of the dummy media.

When the user responds to the inquiry with creation, the dummy media creation unit 232 may detect the media included in the video project and present media that may be configured as dummy media to the user.

A list of the presented media may be all media included in the video project or media selected by setting. In the case of the selected media, the dummy media creation unit 232 may be configured to activate a UI capable of receiving whether or not to restrictively create dummy media, for example, with respect to original media having a capacity larger than a threshold value. The dummy media creation unit 232 may be configured to activate a UI capable of receiving whether or not to restrictively create dummy media with respect to media containing personalized information.

The dummy media creation unit 232 may receive and check at least one individual media selected by the user among the presented media. In the example of FIG. 8A, the user may select original media 702 as individual media. As another example, the dummy media creation unit 232 may receive and check all or part of the individual media selected by application setting.

Next, the dummy media creation unit 232 may generate dummy media information based on the checked individual media (S215).

Specifically, the dummy media creation unit 232 may check individual media information from the individual media. In the example of FIG. 8A, the dummy media creation unit 232 may check individual media information related to the individual media 702. The individual media information may be configuration information of original media related to the selected individual media. The individual media information may include an identifier for identifying each media, a type of media, resolution of media, time information of media, and the like. In the example of FIG. 8A, the information on the individual media 702 may be a unique identifier, video, resolution, time information, and the like.

The dummy media information may be configured to include type, resolution, time information, etc. by referring to the aforementioned individual media information. In the example of FIG. 8A, the dummy media information may be configured by referring to the information on the individual media 702. The dummy media creation unit 232 may generate the dummy media information for all media included in the video project or selected media of at least one media, according to user selection or application setting.

Next, the dummy media creation unit 232 may replace the checked individual media with predetermined dummy media (S220).

Dummy media does not include original media, includes only dummy media formats, and may be composed of media objects of the same type as original media. The dummy media may be a media object prepared in advance by the application. As another example, the application may present a list of dummy media to the user, and the original media may be replaced with the dummy media selected by the user. As illustrated in FIG. 8B, the individual media 702 selected by the user may be replaced with the dummy media 706, and the effect elements 704 added by the user in the editing process may be maintained.

In addition, the dummy media creation unit 232 may perform processing to include dummy media information and dummy media in the video project. In this case, the video project may be processed to include project configuration information excluding the original media replaced with the dummy image. In the example of FIG. 8B, the video project may include dummy media 706, its dummy media information, and information related to various editing elements that are not processed as dummy media, such as effect elements 704.

In this case, the video project may be processed to include project composition information excluding the original media replaced with the dummy image. In the example of FIG. 8B, the video project may include dummy media 706, its dummy media information, and information related to various editing elements that are not processed as dummy media, such as effect elements 704.

Subsequently, the dummy media processing unit 234 may perform external transmission to share the video project including dummy media and dummy media information according to a user request for final sharing processing (S225).

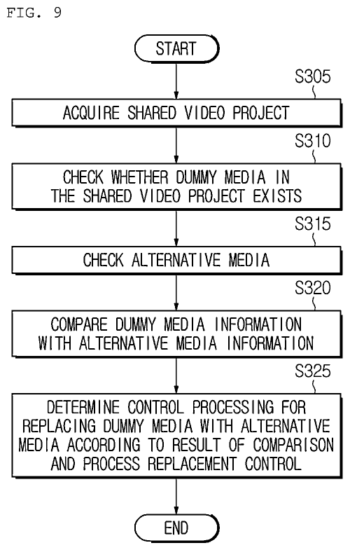

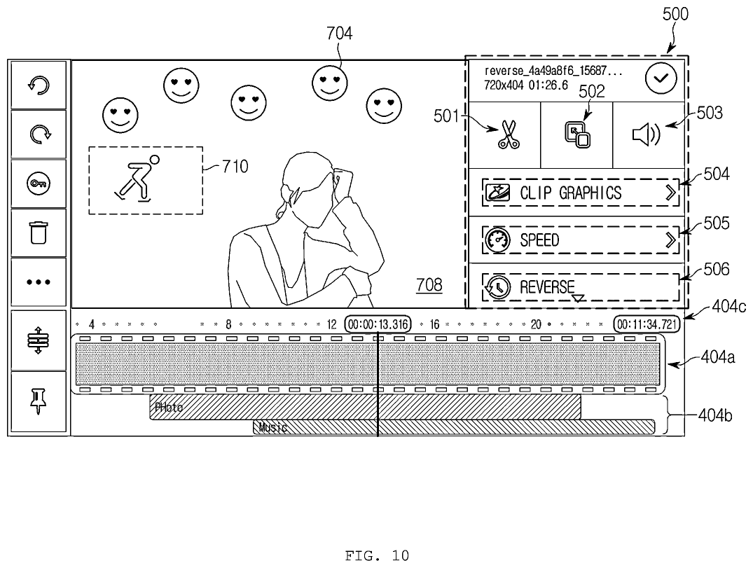

Hereinafter, with reference to FIGS. 9 to 10, in the content sharing method, a process of replacing dummy media including shared content with alternative media of another user will be described.

FIG. 9 is a flowchart of a content sharing method using dummy media according to another embodiment of the present disclosure. FIG. 10 is a diagram illustrating replacement of alternative media according to the process of FIG. 9.

The present disclosure may be performed by merging steps S125 to S145 of FIG. 3. In this disclosure, for convenience of description, an example of replacing dummy media with alternative media selected by a user will be mainly described. However, the embodiment according to the present disclosure may also be applied to an example of replacing alternative media automatically selected by setting of the application with dummy media.

First, a user may acquire a video project including content edited by another user through sharing through a video editing application (S305).

Next, the dummy media processing unit 234 may check whether dummy media included in the video project exists (S310).

If dummy media exists, the dummy media processing unit 234 may extract dummy media information from the video project. In addition, the dummy media processing unit 234 may provide an alternative UI including a menu or UI for modifying media included in the video project to alternative media based on the dummy media information to the user. The dummy media capable of being checked by the user is illustrated as dummy media 706 in FIG. 8B.

Subsequently, the dummy media processing unit 234 may provide a list of media that may be used as alternative media through a replacement UI for selecting alternative media that may replace dummy media, and check the alternative media selected by the user (S315).

The media list may list all media possessed by the user without referring to the dummy media information.

As another example, the dummy media processing unit 234 may configure a list of media based on the type of media, resolution of the media, time information of the media, and the like, which are included in the dummy media information. For example, the dummy media processing unit 234 may configure the list of media by extracting only media having a type of media, resolution of media, time information of media, and the like that match the dummy media information.

As another example, the dummy media processing unit 234 may configure a list of alternative media by extracting alternative media of the same or similar type based on the type of the dummy media. As another example, the dummy media processing unit 234 may configure a list of media by extracting alternative media that is the same based on the time information of the dummy media or set within a predetermined time range.

Next, the dummy media processing unit 234 may compare information on the alternative media selected by the user with the dummy media information (S320).

Specifically, the type, resolution, and time information of the dummy media and the type, resolution, and time information of the alternative media may be compared.

Next, the dummy media processing unit 234 may determine a control processing method for replacing dummy media with alternative media according to the result of comparison, and may process replacement control according to the method (S325).

For example, when information on alternative media selected by the user does not match at least one of information constituting the dummy media information, the dummy media processing unit 234 may control and configure alternative media. Examples of cases where they do not match include cases in which at least one of type, resolution, or horizontal/vertical size of alternative and dummy media is different, and the time information of the alternative media is shorter or longer than that of the dummy media. The dummy media processing unit 234 determines a control processing method suitable for the above-described case, and the method may be, for example, control processing according to the cases described with reference to FIG. 6.

As illustrated in FIG. 10, the dummy media 708 may be replaced with the alternative media 708 selected by the user according to the determined control processing method. As can be seen in the example of FIG. 10, the user may use the effect elements 704 of another user without change and add desired editing elements to the alternative media 708. In addition, the user may create layer media 710 (e.g., video, image, etc.) superimposed on the alternative media 708 through additional editing.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

1. An electronic device for sharing content using dummy media, the electronic device comprising:
an editing UI display unit configured to provide an editing UI including a dummy media creation UI to a display device;
a user input checking unit configured to check user input information received through the dummy media creation UI; and
an editing UI processing unit configured to create at least one dummy media according to input of the dummy media creation UI based on the user input information checked by the user input checking unit and to perform processing to share a video project including the dummy media according to a request.

2. The electronic device of claim 1, wherein the editing UI processing unit is configured to:
detect individual media information as information on at least one media included in a video project and create dummy media information based on the individual media information, and
perform processing to share the video project by including the dummy media information in the video project.

3. The electronic device of claim 2, wherein the individual media information comprises at least one of a type of media, resolution of media or time information of media.

4. The electronic device of claim 2, wherein the editing UI processing unit generates respectively dummy media information for all media included in the video project or generates dummy media information for selected media among at least one media included in the video project.

5. The electronic device of claim 2, wherein the editing UI comprises a dummy media replacement UI configured to check whether at least one dummy media exists in the video project and to determine alternative media corresponding to the dummy media.

6. The electronic device of claim 5, wherein the editing UI processing unit comprises a dummy media processing unit configured to check whether at least one dummy media exists in the video project based on the dummy media information in response to input of a shared video project, to determine alternative media corresponding to the dummy media according to a request in response to existence of the dummy media, and to replace the dummy media with the alternative media in the video project.

7. The electronic device of claim 6, wherein the dummy media processing unit is configured to compare a type of the dummy media, resolution of the dummy media and time information of the dummy media with a type of the alternative media, resolution of the alternative media and time information of the alternative media.

8. The electronic device of claim 7, wherein the dummy media processing unit is configured to select the alternative media in consideration of whether the type of the dummy media, the resolution of the dummy media and the time information of the dummy media match the type of the alternative media, the resolution of the alternative media and the time information of the alternative media.

9. The electronic device of claim 7, wherein the dummy media processing unit is configured to control the alternative media in consideration of whether the type of the dummy media, the resolution of the dummy media and the time information of the dummy media match the type of the alternative media, the resolution of the alternative media and the time information of the alternative media.

10. The electronic device of claim 7, wherein the dummy media processing unit is configured to:
extract media capable of replacing the dummy media in consideration of the type of the dummy media, the resolution of the dummy media, the time information of the dummy media, the type of the alternative media, the resolution of the alternative media and the time information of the alternative media,
providing a list of the extracted media, and
determining at least one alternative media from the extracted media.

11. A content sharing method using dummy media comprising:
providing an editing UI including a dummy media creation UI;
checking user input information received through the dummy media generation UI;
creating at least one dummy media according to input of the dummy media creation UI based on the user input information checked by the user input checking unit; and
performing processing to share a video project including the dummy media according to a request.

12. The content sharing method of claim 11,
wherein the creating the dummy media comprises detecting individual media information as information on at least one media included in a video project and creating dummy media information based on the individual media information, and
wherein the performing processing to share the video project comprises performing processing to share the video project by including the dummy media information in the video project.

13. The content sharing method of claim 12, wherein the individual media information comprises at least one of a type of media, resolution of media or time information of media.

14. The content sharing method of claim 12, wherein the creating the dummy media comprises generating respectively dummy media information for all media included in the video project or generating dummy media information for selected media among at least one media included in the video project.

15. The content sharing method of claim 12, wherein the editing UI comprises a dummy media replacement UI configured to check whether at least one dummy media exists in the video project and to determine alternative media corresponding to the dummy media.

16. The content sharing method of claim 15, further comprising:
receiving the shared project;
checking whether at least one dummy media exists in the video project based on the dummy media information;
determining alternative media corresponding to the dummy media according to a request in response to existence of the dummy media;
replacing the dummy media with the alternative media in the video project.

17. The content sharing method of claim 16, wherein the determining the alternative media comprises comparing a type of the dummy media, resolution of the dummy media and time information of the dummy media with a type of the alternative media, resolution of the alternative media and time information of the alternative media.

18. The content sharing method of claim 17, wherein the determining the alternative media comprises selecting the alternative media in consideration of whether the type of the dummy media, the resolution of the dummy media and the time information of the dummy media match the type of the alternative media, the resolution of the alternative media and the time information of the alternative media.

19. The content sharing method of claim 17, wherein the determining the alternative media comprises controlling the alternative media in consideration of whether the type of the dummy media, the resolution of the dummy media and the time information of the dummy media match the type of the alternative media, the resolution of the alternative media and the time information of the alternative media.

20. A computer program stored in a recording medium readable by a computing electronic device in order to perform a content sharing method using dummy media in a computing electronic device, the method comprising:
providing an editing UI including a dummy media creation UI;
checking user input information received through the dummy media generation UI;
creating at least one dummy media according to input of the dummy media creation UI based on the user input information checked by the user input checking unit; and
performing processing to share a video project including the dummy media according to a request.
